(19) United States
(12) Patent Application Publication
(10) Pub. No.: US 2003/0177055 A1
(43) Pub. Date: Sep. 18, 2003

(54) Virtual test market system and method

(75) Inventors: Paul Jacob Zimmerman JR., New Richmond, OH (US); Delaine Sue Bower Hampton, Toronto (CA); Kristin Leigh Sharp, Cincinnati, OH (US); June Irene Hahn, Loveland, OH (US); William Harry Rocklin, Cincinnati, OH (US); Erik Daniel Barthel, Cincinnati, OH (US); Tod Randall Taylor, Cincinnati, OH (US); Robin Mathews Cox, Cincinnati, OH (US); Richard Terrence Lynch, Cincinnati, OH (US); Michael William Freeland, Loveland, OH (US); Susan Terry Azmier, Toronto (CA); Christopher John Hannaford, Toronto (CA)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/097,398

(22) Filed: Mar. 14, 2002

(51) Int. Cl. G06F 17/60

(52) U.S. Cl. 705/10

(57) ABSTRACT

Systems and methods for conducting a virtual test market are disclosed. A system may include a virtual launch component, a transaction component, and a marketing simulation component. The components of the system may be used in combination to obtain, and analyze marketing data relating to a new product offering at a substantially reduced cost and resource level as compared to conventional techniques. The systems and methods disclosed may also be used to perform scenario analyses.

### FIELD OF THE INVENTION

This invention relates to systems and methods for conducting a “virtual test market” of a new product offering. The system may provide an integrated tool which allows users to gather, generate, and analyze data needed to launch a new product offering without first conducting a conventional test market.

### BACKGROUND OF THE INVENTION

Throughout the world, thousands of new consumer products are sold for the first time or “launched” each year. Most of these products ultimately do not succeed in the marketplace for a variety of reasons. Because of the uncertainties associated with launching a new product offering, most sophisticated manufacturers (such as those with national or global reach) will not typically launch a new product without first conducting one or more “test markets.” A typical test market may consist of manufacture and sale of a new product offering in a selected city or region in order to collect a variety of data, make any final adjustments to the product or its support plans, and to make a final decision regarding whether or not to commit the resources necessary for a national or international product launch. Many current test markets (or “conventional” test markets) may be referred to generally as “physical” test markets because they at least partially rely on physical manufacture and sale of product in a representative market setting. Because construction of manufacturing capacity, purchase of materials, providing sales support, generating advertising, and other activities are expensive and require significant resources, the results of a test market are important in obtaining “real world” information regarding the likely ultimate success or failure of the launch at a reduced cost.

Nevertheless, even the “reduced cost” (as compared to a full-scale national or global launch) of a test market for a consumer product is substantial. Conducting a conventional test market even in a single city is a complex and resource intensive activity. Even prior to making the commitment to a test market, sophisticated manufacturers of consumer products will typically seek to establish that the product has acceptable product performance versus competition. This is typically accomplished by measurements obtained through testing such as one or more of the following: Single Product (Monadic) Blind Tests, Concept Aided studies, Concept and Use Studies, or Pair Testing. These studies are typically done by an agency that has pre-recruited a representative group of consumers to evaluate the product for a specified testing period (which may be different for each category of consumer goods). This product performance testing is typically done to determine whether or not there are any critical issues that could limit success in the marketplace. Testing can be blind or with the product identified. The majority of fast moving consumer goods are tested monadically—although pair testing is done in some cases. These tests may take an average of 4-8 weeks to field, test and tabulate the results.

Another typical item of pre-test market research to conventional test market among consumer product manufacturers is to demonstrate that the product can meet the desired volume projections. This typically entails a concept and use test where people are exposed to the concept of the test product alone, and are then allowed to use it for a period of time, after which they are asked for their interest in purchasing the product. These estimates are then translated into a volume projection using established tools. A third major pre-test market activity among typical manufactures is to ensure that the product can be produced in sufficiently large enough quantity for the proposed test market. Because a controlled or geographic test market can typically represent 1-5% of the US population, the quantities of product needed for a one year test market can be large enough that significant resources are needed to produce the product. Even though production quantities are less than those for full-scale national production, small production runs at full-scale manufacturing plants may be required. Such production runs may require nearly the same level of effort and resources as large scale (such as national) production would require.

Many manufactures prior to test market will typically want to identify and produce the mix of marketing materials necessary to create awareness of the product and to educate the consumer, as necessary. This step frequently requires significant involvement of an advertising agency over an extended period of time, lengthy consumer research to define and refine the marketing proposition, and finally the resources necessary to produce large enough quantities of marketing materials for the test market. Often, coordination with local media is required (for coupons, newspapers and magazines). Local channels (e.g. food drug and mass-merchandisers) are contacted for shelving arrangements and in-store promotion materials), and local media might be contacted to make them aware of the potential newsworthiness of the test product.

A conventional test market execution itself will typically require market research in sufficient depth to understand the consumer's reaction to the idea, and to measure their trial and repeat purchase behavior. While some of the required data collection may be accomplished via either store level or household level scanner data (collected automatically), much of it often has to be done using specially recruited panels or groups of people. It is readily appreciated, then that planning for, preparation of, and execution of a typical test market for a new product launch is a complex, expensive, and resource intensive exercise.

The “conventional” test market methodology of manufacturing physical products, having consumers test them (alone or versus competitive products), selling them in a test market, and collecting data regarding the impact of the new product in stores and through consumer panels has several drawbacks. For example, there is high economic and commercial risk associated with commitment of resources to a full scale product launch. Because of this risk, a manufacturer will typically want to ensure that product qualification testing is done with a large base of representative consumers and sufficient numbers of specialized over-quota groups (such as past three month brand users, or any particular target group). Regulatory and safety considerations must also be addressed and approvals from government agencies are usually required, since selling a product in a test market is usually subject to the same regulations as any other commercial activity. It will be readily appreciated that for many companies, simply choosing what product to place in a Test Market can be an involved and high-risk decision.

Another drawback of conventional test market techniques is that arriving at a pre-market estimation of the volume potential of a new product is a complicated and time consuming process with its own set of limitations. Predicting sales volume at the end of one or two years after a product launch necessitates that the consumer be exposed to both samples of the product and samples of the marketing materials. Unfortunately, in many pre-test market activities the stimulus that the consumer is shown is typically either a print advertisement or a piece of advertising copy for the test brand only. While this method of volume estimation works quite accurately, there are some shortcomings.

It is well documented in the diffusion of innovation literature that different people like to learn of new products different ways. Some people like to hear about products from friends, some look for new coupons and some prefer to either see commercials or read magazines. However, due to the time, cost, and resources constraints of many pre-test market activities, often the consumers only have the opportunity to view a single type of stimulus. This is not only non-optimum for the consumer, but it forces the test marketing company to create a concept stimulus that appeals to the most people. This sometimes makes such a stimulus a “lowest common denominator” type of stimulus.

Another shortcoming associated with sales volume prediction is that the sales volume estimation process depends upon consumers responding to attitudinal questions such as a purchase intent (with choices including, for example: definitely will buy, probably will buy, might or might not buy, probably will not buy, definitely will not buy, etc.) and likely purchase frequency (with choices such as less than once a year ranging to once a week) It is well known that consumers tend to overstate their responses on these questions. While these results are known to be reliable, it does require that a person practiced in the state of the art have algorithms, based on past experience, that allow them to understand the degree of overstatement in these consumer responses. Only once the overstatement is removed, can the extent of awareness and trial be accurately predicted. A limitation of this type of forecasting is that the algorithms are only accurate if the present marketing plan is similar to what has been done in the past. A recent trend among marketers is to try many newer direct to consumer, internet, and event marketing devices. Marketers are also expanding into new geographies where no testing has been done. Both of the situations illustrate the severity of the limitation of depending on algorithms from past research. Without accurate algorithms, there is a higher degree of error in sales volume predictions.

Conventional test marketing techniques also face the challenge of producing adequate product quantity. A manufacturer of consumer goods must be able to produce goods of market quality in often significant quantities simply for the test market. In the test market context, this can be a challenging requirement. For example, a manufacturer may be required to arrange for procurement of large quantities of raw materials to support a full scale production run even though it may be short in duration. This in turn, may necessitate a secondary supplier to produce a raw material in full scale equipment in their facilities. This scale of production cascades down thru the supply chain demanding significant efforts in coordination, risk reduction and allocation, cost, and timing.

Exposing consumers in a conventional test market to marketing materials presents several challenges. It is known that exposure to both the new product and its associated marketing materials are necessary to obtain the data needed for reliable predictions of sales volume on the basis of the test market results. However, significant lead time and logistics considerations are usually associated with purchasing the desired television and other advertising spots. Typically, spot (local) media must be purchased and it must be done so several months in advance of desired airing. This commitment must often be made before the optimal marketing materials for the product are developed and once made, cannot easily be altered if a change in the materials is desired. Additionally, once a conventional test market starts, there is often little to no opportunity to alter aspects of the approach on the basis of in-progress results. Consequently, a company desiring to modify the launch of a new product is left with the choices of conducting a new test market (with all the associated expenses and issues described above) or trying to predict the effect desired changes might have had on the results actually obtained in the initial test market.

A final significant drawback to conventional test market techniques is the effect competition can have on the ability to obtain accurate and reliable data. Conventional test markets (especially those that are nearly completely “physical” test markets) tend to be public in nature. It is often impossible to conduct such conventional test markets with any significant degree of stealth. Conventional test markets, therefore, typically involve as a by-product exposure by the manufacturer of insights, products, and to some degree marketing plans to competitors.

In many situations in which a company is test marketing a new product offering, existing products will serve as the competition to such a product. Furthermore, the manufacturers of the competitive products will often be aware of the existence of the test market product and will respond accordingly (for example, to conduct their own testing of various response measures). A variety of typical competitive responses can skew data collection. Some common examples are that competitors may increase the number of coupons available to consumers for their products (i.e. the competition to the new product offering). Both the absolute number and the value of the coupons are variables manipulated easily by a competitor. The end result is that the test product may appear less attractive to the consumer or consumers may stock up on enough competitive product that they do not repurchase the test product at their normal rate. While trial targets for the test product may be attained, stocking up on competitive product (due to the coupon incentive) may reduce repeat volume for the test product giving the manufacturer of the test product a false negative result. Competition may also increase in-store promotions for their products. Increasing displays or utilizing temporary price reductions is relatively easy to do for a competitor and has the same effect as a coupon: it decreases the economic appeal of the test market product. Again, a false negative result would be apparent.

Even competitive product purchase can be problematic for a company conducting a conventional test market. If a truly new product were sold in a test market, a competitor would naturally wish to purchase enough of it to conduct their own market research on the appeal of the product itself (such as in a blind test) and the appeal of the combination of the marketing materials and the product together (such as in a concept and use test). Depending on the size of the test market, the purchase of these materials by competitors may give the test market product manufacturer a false sense of high volumes sold, particularly in the first few months of introduction. It is also possible for a competitive product manufacturer to air new copy regarding its own products, which addresses real or supposed differences between their product and the new test marketed product. Typically, such copy serves to reduce differences between the two products and minimize volume of the test product in the test market.

In light of the numerous financial, logistical, and technical challenges associated with typical conventional test marketing, a need exists for virtual test market systems and methods. The advantages of such systems and methods will be apparent in light of the description below.

### SUMMARY OF THE INVENTION

The present invention relates generally to test market systems and methods. In one example of a system of the present invention, the system may include a virtual launch component. This virtual launch component may be capable of generating data regarding product choice probability. The system may also include a transaction component. This component may be capable of generating data regarding product repurchase. The system may also include a marketing simulation component. The product choice probability data and the product repurchase data may be input into the marketing simulation component. The marketing simulation component may contain an agent based model which utilizes said product choice probability data and said product repurchase data.

In one version of the system, the product repurchase data may comprise information regarding both product repurchase probability and frequency. The virtual launch component may be capable of exposing consumers to marketing materials. It is possible that the virtual launch component is executed via one or more interactive computer based systems. Additionally, the transaction component functionality may be provided using one or more interactive programmed computers.

In one version of the system , the system is capable of modeling the market input of a competitive response. Competitive responses which may be modeled may include manufacturer coupons, advertising, pricing specials, and end-aisle displays.

A method of the present invention may include a step of recruiting a representative plurality of consumers. Another included step may be providing these consumers with access to a virtual launch component. An included step in a method of the present invention may include gathering data regarding the product choice probability of the consumers using the virtual launch component. An included step may be providing consumers access to a transaction component. Another included step may be gathering repeat purchase data using said transaction component. Inputting the choice probability data and the repeat purchase data into a marketing simulation component may be another included step. A method of the present invention may also include a step of utilizing said marketing simulation component to model consumer behavior using an agent based model.

In one version of a method of the present invention, a step of recruiting a second plurality of representative consumers may be included. This step may be included between the steps of gathering data regarding product choice probability and the step of providing consumers access to a transaction component.

Individual steps of the method of the present invention may be accomplished by means of one or more programmable computers. These steps may include providing access to the virtual launch component, providing access to the transaction component, and utilizing the marketing simulation.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings, in which:

FIG. 1 is a block diagram representing the basic components of a system of the present invention.

FIG. 2 is a flow diagram depicting steps in a method of the present invention.

### DETAILED DESCRIPTION OF THE INVENTION

This invention relates generally to virtual test market systems and methods. In order to provide a more detailed understanding of the systems and methods of the present invention, specific embodiments or executions of such systems and methods will be described. These embodiments are meant to be representative and are not exhaustive examples of the manner in which the invention may be practiced.

While the invention is titled and described as a “virtual” test market, such a term does not mean that all aspects of systems or methods of the present invention must be computer based or rely on similar technologies. As will be discussed further below, several aspects of systems or methods of the present invention may be practiced using traditional or conventional elements such as hard copy advertising samples, questionnaires, and the like.

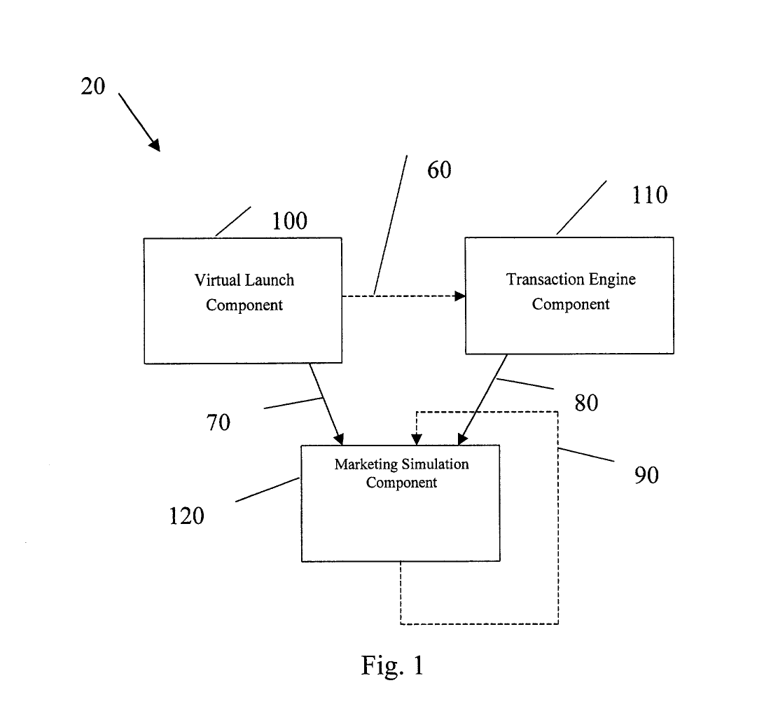

FIG. 1 is a block diagram that represents the basic components that may comprise a system of the present invention. It should be understood that these components shown and described are illustrative and that systems according to the present invention may have a configuration different from that shown in the figures.

As shown in FIG. 1, a test market system 20 of the present invention may comprise three basic components. These may include a virtual launch component, such as virtual launch component 100, a transaction component 110, and a marketing simulation component 120. These components may be provided as different “modules” within an integrated system, but it is not necessary that this be the case. For example, each of the components could be “stand alone” in the sense that they do not use the same materials, equipment, personnel, or other means of operation even though taken together the three components are used in combination to form a single test market system. Sufficient relatedness of the components is established to form the system of the present invention when data, output, or other results from one component is used to form part of the input to another component. For example, as will be further discussed below, FIG. 1 shows a relationship where information generated by using virtual launch component 100 and transaction component 110 is fed into marketing simulation component 120 as input. This flow is represented in FIG. 1 as lines 70 and 80. This is just one representative example of such data or information flow, and many others are possible as will be further discussed below.

A first component of the virtual test market system 20 may comprise a virtual launch component 100. The virtual launch component 100 may be thought of as a mechanism, technique, system, or method to expose target consumers to both a product shelf set and a variety of marketing stimuli. The virtual launch component 100 may utilize a disaggregate discrete choice model that is applied to choice data collected from the responses of the targeted consumers. The virtual launch component 100 may be a computer based system and the product and marketing exposures, as well as the data collection could be accomplished using one or more computer systems. It is also possible that some or all aspects of the exposure and data collection could be accomplished without any computer systems.

The virtual launch component 100 of the test market system 20 may be best understood by a description of one particular embodiment of such a component. This description is not intended to imply that other embodiments are not possible or are not envisioned within the scope of the present invention.

The virtual launch component 100 designed to collect data from consumers regarding the likelihood that the test product will be selected or chosen. For purposes of the present description, the terms “test product” and “reference product” are interchangeable and will refer to any product which is the product of interest in a given context. In other words, if a user of the test market system wants to collect, analyze, and engage in scenario simulation with respect to a particular product (or even a set or products), then the subject product will be the “test product.” In many cases the test product will indeed be a “test product” in the sense that it is not yet generally available in the market and the user of the system is intending the use of the system to serve as the “test market” for the “test product.” It is not, however, necessary that the test product be previously unavailable, experimental, or have any other special or particular characteristics respecting a “test” nature. Test refers to use of the system and not necessarily the reference product itself.

The virtual launch component 100 serves to expose consumers to conditions which could be experienced in the marketplace once the test product is available within the available market mix. This includes exposure to current competitive or alternative products, including the choice to avoid purchase of any product, as well as both in-store and out of store marketing stimuli which a consumer is likely to experience via planned marketing support activities. The virtual launch component 100, also serves to collect from consumers information sufficient to determine the choice likely for consumers of the test product as well as for competitive or alternative products, and even for no product choice in a given category. It should be noted that “competitive” or “alternative” product in this context does not necessarily refer to products made or sold by others, but may include the user's own products to the extent such products might represent alternatives choices to the consumer as compared to the test product.

Basic constituent elements of the virtual launch component 100 may include a shelf set, pricing information, and marketing materials. Each of these will be described in turn. The term “shelf set” refers to a representation of a consumer store shelf (e.g. retail or club type store) containing products in the category most associated with the test product. For example, if the test product is a new type of floor cleaning implement, the category of products included in a shelf set might include currently available mops, cleaners, brooms, sweepers, cleaning solutions, and the like.

The shelf set when well designed may include enough product SKUs to adequately represent the category in the minds of the consumer. Since some categories have hundreds of SKUs, it will not always be necessary or even desirable that all available SKUs be shown. However, if the category is not confusing, then it may be desired to show all SKUs. The shelf set may be designed with respect to a given test product to include those existing brands that represent at least 80% of the volume for a given category (i.e. the category of products the test product is in or is expected to be in). The shelf set may include the largest selling SKUs for the sales channel being studied. In well designed shelf sets, the same sizes may be shown for all brands. This may be done in order that an accurate price/feature comparison can be made by the consumer. If more than one product form is available in a category, both forms should be shown. This may particularly be desired if there is a sizable group of consumers (for example, greater than 10%) who would not choose that brand if the form were not available (an example might be liquid and powder Automatic Dishwashing Detergent). Key category product versions may be either shown physically on the virtual shelf or be “available” when the consumer's computer mouse rolls over the brand (if a computer based execution of the shelf set is used, for example). An example of showing varying key category product versions might be unscented liquid laundry detergents because, similar to product form, consumers may not buy the brand unless they know that version is available. An example of a mouse-over is a banner that appears when the consumer's mouse rolls over an included shelf set band (such as “Tide”) that says (in this example) that it is available in Free and three scent versions. Product versions which are unique because they are premium (absolute or “peruse”) priced may be desired to be physically shown on the shelf in the size closest to the regular version. An example is the “with bleach” version of powder detergents which sell for the same shelf price as regular detergent but which offer 26 uses per carton compared to 32 uses per carton for the largest selling size of regular detergent.

In addition to a shelf set, another constituent element of a virtual launch component 100 may include pricing information. It may be desired that the regular product prices shown reflect reasonable non-promoted prices that the consumer would typically see for a given shelf set. Prices taken from combined Food/Drug/Mass scanner data for the 13 week period prior to the study placement may be desirable as an example. But if the test design was to evaluate Mass Merchandizing pricing as a second example, mass merchandizing specific prices may be desired to be used as the pricing information for the shelf set. It may be desired to round prices to the nearest 9 cents for purposes of verisimilitude (at least in North American based consumer outlets). In well designed virtual launch components 100, the pricing information element uses correct relative prices between brands included on the shelf set and the prices of the line of items within a brand are realistic. Frequently, it is the case that brands are priced identically for all versions within a given brand size, but if this is not the case it may be desired for the pricing information of the virtual launch component 100 to reflect actual pricing information. If items included in a given shelf set are, or may be subject to feature, deal, or display pricing it may be desired to include such information in the pricing information of the virtual launch component 100. In any event, the virtual launch component 100 may be provided with the capability to model the presentation of the featured pricing (or even up-pricing) to consumers in order to collect data on choice probability as a function of price (i.e. price sensitivity—either for the test product or competitive products).

It may be desired in well designed virtual launch components 100 to use feature or display prices in the pricing information for a given shelf set which reflect reality. In a typical price feature example (seen in the market), a reduction in price of 10-15% is shown and is applied to either the brand as a whole or one version of the brand shown, such as the ‘with Bleach’ version mentioned in the above example. A well designed virtual launch component 100 may mathematically control the percent of instances that pricing information reflects a “feature price” in order to reflect real store conditions typical for a particular market. In other words, not all consumers will be exposed to a feature price in a conventional test market, because the price feature may be of a limited duration, it may only exist in some stores or channels, etc. The virtual launch component 100 can account for this by determining the appropriate percentage of consumers who would be exposed to a changed price, and randomly showing that percentage of consumers using the virtual launch 100 component of the system 20 such a changed price.

As noted, the virtual launch component 100 of the virtual test market system 20 may comprise a disaggregate discrete choice model. Such a model may allow for the incorporation of a price higher than normal for the test product in order to better understand the price sensitivity of the product across a broader range. For example, users of the system may desire to test the impact of price differences ranging from 75%-125% of the expected target price. In general, the pricing that a consumer may see on any one product on any one virtual shelf may be mathematically controlled by a discrete choice or conjoint type of design. In well designed versions of the virtual launch component 100 not every brand should go on display at one time, and the brand versions that go on feature together in actual retail settings should also go on feature together in the virtual launch component 100.

A third constituent element of the virtual launch components 100 may include marketing materials. The virtual launch component 100 best simulates and measures the choice likelihood with respect to the test product and alternatives when consumers are exposed to shelf sets likely to be seen in the physical stores as well as to associated marketing materials. Ideally the marketing materials element of the virtual launch component 100 would capture all possible marketing activities that could occur in market for the test and competitive products. It is not necessary, however, that all possible materials be included, but a greater number is usually more desirable. In well designed versions of the virtual launch component 100, the scope of the marketing materials is not overly limited for the test. In a well-designed execution of the virtual launch the test design will allow the marketer/manufacturer of the new product to identify the best marketing elements based on the consumer reaction during the test, as opposed to prejudging or choosing only one stimulus ahead of time. It is also desirable to use a selection of marketing materials from all key brands in the shelf set. In other words, consumers may be exposed to samples of marketing materials (advertising, coupons, etc.) associated with competitive products as well as the test product. Such an approach allows for a more realistic consumer reaction to the test product by exposing the consumer to the test product in the context to what other products are currently available (such as competitive products).

In one example execution, television copy may be shown for products that will be available on the shelf set. Any acceptable quality of copy can be placed in the competitive reel, although may be desirable that all pieces of copy have the same level of finish. In other words, if the quality level of sample television copy is “quick and rough” production quality, then copy for all products may be presented with similar quality. A similar approach may be used if “finished” production quality is desired to be made available. While no particular level of copy quality is necessary, users of the system may wish to select at least a level of quality sufficient such that the consumer would not be distracted from the main message of the copy by poor production quality. In order to obtain the best possible results from the virtual launch component 100 it may be desired, for example, to avoid in the marketing materials obvious voice-over translations or animatics for the test product copy if finished copy is being used for competitive products. It is not always necessary to follow this approach, however.

In one example marketing materials used in the virtual launch component 100 consumers may be exposed to copy of approximately equal lengths (for example, ranging from 15-45 seconds) and the total length of time for all TV copy may be under 5 minutes. Magazine print ads may be shown for all brands. These can be one or two page ads, as appropriate for the category. It may be desired to use comparable quality of all ads. Coupon Inserts (FSCIs) may be made available as appropriate for the category. Again, it may be desired that FSCIs for all brands that use FSCIs be made available and the copy quality be comparable. The coupons may have Bar Codes, to increase realism, although they do not have to be real bar codes. Expiration dates for coupons may be removed or extended to a date that is after the study placement date. Other marketing materials could include representations of end aisle displays to reflect what would actually occur in-store. Such a feature may be used in conjunction with store shelves, as discussed later. One possible example is a picture of the display situated next to the appropriate shelf and controlled mathematically so that the percent of “shopping trips” (typically individual uses of the virtual launch component 100 by a given consumer) where the display is present is neither too high or too low relative to what can be achieved in market.

In one example execution, an in-store display may be shown in about 30% of store visits (as represented by discrete users of the virtual launch component 100 by a consumer). Of course, alternate shelf layouts or displays could be tested by having multiple “cells” in the research. In such a scenario is may be desired to make sure there is sufficient statistical strength in each cell to analyze the data so obtained. A short (for example 5-10 second) video of a billboard may be shown to consumers during the course of a given use of the virtual launch component 100, as discussed later. This is one example of a “push” component. A push component refers to a component (such as a billboard in this example) that the virtual launch component 100 will show to consumers without consumers requesting it on their own. A consumer user of the virtual launch component 100 may be given the option to see a short video of an in-store demo. If such an option is provided and not selected, then the consumer may be given a second chance to see the video by the virtual launch component 100. In one example, such a video is approximately 30-60 seconds in length. It may be a simulated demonstration or a video of an actual demonstration from a real store, as appropriate. Again, in one example a predetermined percent of consumers may see this component of the marketing plan, according to the mathematical design of the virtual launch component 100.

It is also possible to include public relations materials in the virtual launch component 100. Such materials can be quite varied, as necessary. They could include, but not necessarily be limited to: newspaper or professional journal articles, audio tapes of radio interviews, a video or picture of a sponsored event, or any other representation of events where consumers would learn about a new product or brand. The marketing materials element of the virtual launch component 100 can even be configured to model word of mouth effects. Because consumer word of mouth (either positive or negative) can be quite important to the success or failure of an initiative, and is known to be an important source of information for many consumers, it may be desired to model and include such word of mouth as a source of awareness. In one example, a consumer could see either a short video of different people talking about the products or they could select various people from a picture and read or hear what such selected people have to say about the product. A well designed virtual launch component 100 may include as many sources of information a consumer would normally use to learn about a new product as is possible. In well designed virtual launch components 100 of the present invention, the frame of reference for a decision on what to include regarding marketing materials is the consumer (and not the marketer or product manufacturer). Both paid and not paid sources of information may be included as necessary.

Having described the basic constituent elements which may make up the virtual launch component 100, an example of one integrated virtual launch component 100 of the present invention will now be described. This description is provided to enhance understanding of how pieces of the virtual launch component 100 may be included and work together, and not to suggest that such a particular configuration is necessary to practice all versions of the virtual test market system 20 of the present invention.

In one example, the virtual launch component 100 may be run using a computer, although it is perfectly acceptable to utilize a physical setup as well. The execution can be either on a computer at a central location such as a mall or research facility. In other examples, a computer based virtual launch component 100 could be provided via web-TV or Internet or by a pre-recruited panel of computer owners.

Assuming the virtual launch component 100 is provided in one example using a computer or series of computers, a consumer may use such a computer as the interface to the virtual launch component 100. Each consumer may be asked a series of screening questions to insure they qualify for the study. These may be category usage questions but could also include demographic or social status questions as appropriate for the category.

In one example virtual launch component 100 selected consumers (i.e. those who qualify according to the screening criteria chosen) are given a sealed envelope that contains enough money to cover a future purchase in the category. The amount of money given may be enough to cover 1-2 products in the category, depending upon the test design. For regulatory purposes, it may be necessary in many countries to provide testing consumers with money for test purchase purposes as opposed to the consumers using their own money. The selected consumers may be shown a series of store shelves represented on a computer screen. They may be told to assume that they are running low on products in the category and be asked to purchase whatever products they would normally purchase. Consumers using the virtual launch component 100 may select a product off of the shelf (either virtually or in person for a physical set-up) or they may choose multiple products from subcategories as necessary. As an example, for hair care products consumers may choose a shampoo, a conditioner and styling aids as appropriate.

It may be desired to vary prices at each shelf that the consumer sees. Products may be “flagged” by any suitable means as being on sale as evidenced by a tag on the shelf in a manner similar to that a consumer would see in a store. The prices that are shown for each product may be controlled mathematically by the design of the discrete choice experiment.

In one example of a virtual launch component 100, the consumer may be asked to go on 3-7 shopping trips at this stage of the research. This allows the accurate estimation of price sensitivity and product loyalty for each consumer. In this particular example, these first several “shopping trips” (conducted either virtually or in a physical shelf setting) are conducted before the test product is included. This is done to collect “baseline” data on the choice probabilities before the test product launch.

The virtual launch component 100 may be provided with the capability of modeling the marketplace at times representing both prior to and after the availability of the test product. In one example of using the virtual launch component 100 after availability of the test product, the consumer may be told that a new product is available in the category. A computer screen may be shown to the consumer with all elements of the marketing plan available for selection. The consumer may be told to choose those sources of information that they would normally choose to learn about a new product in this category. It may be desired that the virtual launch component 100 not force the consumer to see something. For example, consumers may be given the option of stopping a particular marketing element if they so choose and then moving on to another element. It has been found during development of the present invention that consumers typically choose 2-3 elements that are available, and different people choose different elements. In this example, after exposure to the marketing elements as described above, the consumer may be asked to again go shopping under the premise that the consumer is again low on products at home. However, this time, the test product may be available on the set of shelves. It may be a new item or a replacement for an existing item, as appropriate. Again 3-7 shopping trips may be completed, which allows an estimate of the importance of the marketing materials in conversion to trial.

After the shopping trips described above are complete, the consumers may be told that they now have a chance to actually purchase one of the products they saw on the shelves if they so desire. It may be stressed that they can buy any product and, just like a regular shopping trip, they do not have to purchase any product if they do not so choose. The consumers may be informed that that the envelope they had received earlier contains a certain quantity of currency that is theirs to use as they wish. At this point, the consumers may purchase a product, and may be given both change and a product to take home. It may be desired to actually give the consumers actual physical products which correspond to those selected. This may be done even if the selection is accomplished using representations (such as pictures) on a computer. As appropriate, it may be desired to sample a group of people with the test product. This can either be a smaller version (i.e. consumers could be provided with unsolicited “sample size” products), as would occur in market, or a full size product. It should be noted that the consumers sampled in this manner may represent a different group of consumers than those who conduct the shopping trips described above, or the same groups of consumers may be used. After the appropriate usage period (1-4 weeks, depending on the category) the consumers who received the test product may be mailed (or receive via computer) another set of 4-7 shelves. These consumers may circle (or otherwise indicate, such as by “clicking”) the products they would like to buy in each occasion (as before) and may then be recalled by phone or other means or in person. By providing this set of purchase occasions data regarding an estimation of the effect of product usage on trial and repeat may be obtained.

One suitable example of a configuration which may be used as a virtual launch component 100 of a virtual test market system 20 of the present invention is described in Co-pending U.S. patent application Ser. No. 09/874,853 filed on Jun. 5, 2001, which is hereby incorporated by reference.

A second component of a virtual test market system 20 of the present invention may comprise a transaction component 110. One purpose of the transaction component may be to estimate the true repeat rate for a test product, based upon real consumers purchasing test products and using it in their homes.

In one example execution, the transaction component 110 may comprise an internet (or otherwise computer modeled) based set of shelves that may be similar or identical to those used in the virtual launch component 100. Specifically, in this example, the shelves that contain the test product used after consumers see the marketing materials. It may be necessary to provide a mechanism for all relevant legal, safety, and regulatory information to be displayed or otherwise made available to users of the system. These requirements will, of course, vary by country and product type. Prices may be established at the non-promoted price. Alternative embodiments could be either a mail catalogue or a physical store shelf in a mall, as an example, where consumers may repurchase the product, or the use of an on-line grocery company.

In a conventional shelving or in-market merchandising test, a manufacturer may often choose to vary a number of parameters in an effort to establish whether or not these parameters would make a difference in trial and/or repeat rate for a given product. Such an effect can also be accomplished in the transaction component 110 of the virtual test market system 20 by separating the static sample into two or more cells. Ideally in such a scenario, statistical validity of the data will be preserved by taking into account the expected repeat rate and purchase cycle.

In one example of a transaction component 110, the consumers who use the transaction component 110 are a static group comprised of consumers who are willing to shop on-line. Of course, if the transaction component 110 is not executed in an on-line format, such willingness is not required and a willingness to shop using whatever mechanism the transaction component 110 is executed with is all that is required. It may be desired to have the user group of consumers security screened, for example to screen that such consumers are not employees or family members of employees of competitor firms. Total base sizes for users of the transaction component 110 may be in the 1000-2000 households range. Such base sizes allow for division of the consumers into multiple cells as necessary or to permit testing of products having low repeat rates or trial rates.

If a computer based (for example, using a computer network such as the internet) execution is used for the transaction component 110, panelists may be given a ID and password that permits them to access the computer-based transaction component 110. It may be desired to inform the consumers at recruitment that they will be given the opportunity to purchase products, some of which may be new to their area, by using their own money. Due to regulatory requirements in many countries, it may be necessary to avoid characterizing this as a market research study.

In one example of a transaction component 110, consumers may see shelves for multiple categories and be able to shop any category they choose as many times as they choose. The transaction component 110 may be provided with the capability of allowing the user to proceed to a ‘checkout lane’ and pay for the transactions using any suitable means such as with a credit card. The checkout line may be simulated or “virtual” in a computer based transaction component or may be a physical, more traditional outlet. If a computer based purchase takes place using the transaction component 110, any product purchased may be shipped to the consumer. It may be desired in order to obtain more realistic pricing to not charge for such shipping.

In one example of a transaction component 110, no awareness generating information is provided through the component during the first 1-2 weeks a new shelf or test product is made available. “New shelf” simply refers to a shelf configuration which contains one or more test products as that term is used herein. In this example, after one-two weeks (which represents a typical time period between stocking the shelves and start of marketing associated with a conventional market launch), an appropriate educational flyer may be sent to panelists electronically or through any other suitable means. Alternatively, TV copy or a magazine ad could be sent to the consumer electronically or using other suitable means. A purpose of such information may be to build awareness and understanding of the product benefits. It may be desired to avoid testing alternative copy strategies if this approach is used. It may also be desired to take appropriate care not to bias the consumer in favor of the advertised product with any unnecessary “sell” language if awareness of the test product is the desired objective.

In an example of the transaction component 110 a manufacturer who places a test product transaction component 110 may decide to honor competitive coupons or to permit more frequent marketing events to the panelists, if this is judged as desirable. Shipping of the product may or may not be free, depending on the desired purposes of the test. It may be desired to give various bonuses to consumers to provide incentives for them to visit the “store.” In such cases, however, it may be additionally desired to ensure that any bonuses given relate to the use of the transaction component 110 itself and not to the selection or trial of any given product offering.

The virtual launch component 100 is a mechanism or combination of mechanism designed to replicate the exposure to representative consumers of the availability of a test product as well as to its supporting marketing activity. The purpose is to obtain data and measurements regarding the choice probability for individual consumers of selecting the test product (and its competitive products) given realistic exposure simulating actual in-market conditions and exposure to realistic representative marketing materials. The transaction component 110 may be conceptualized as simply a shopping and purchasing forum or other mechanism which includes the test product in a realistic setting (for example, in the context of being available with competitive products). Any existing retail store or catalogue or electronic shopping forum could be used as a transaction component 110. However, these existing forums are not likely to offer the test product. Additionally, it is desired that the transaction component 110 be capable of collecting data and generating measurements regarding the re-purchase likelihood and frequency of the test product, especially in comparison to competitive product. Because of this desired capability it may be necessary for a manufacturer to “sponsor” a transaction component 110 on their own. This however, is not required. It may be suitable to include availability of a test product in an existing purchase forum, particularly if there is a mechanism for collecting data regarding consumer purchase frequency of the test product.

The virtual launch component 100 and the transaction component 110, then may exist completely independently of each other. In some versions, however, there may be some relation between these components. This is depicted in FIG. 1 by dashed line 60. An example of such a relationship may be that a single computer system is used to provide the capabilities of both the virtual launch 100 and transaction 110 components. Another example, may be that information is shared or is otherwise common (such as use of overlapping representative consumers) between the components. As noted, it is not necessary that there by any relationship or interaction between these components at all. Any or all of the features, functionality, or capabilities of the “in channel” system described in co-pending U.S. patent application Ser. No. 09/874,583, filed on Jun. 5, 2001 may also be suitable for use as a transaction component 110.

A third component which may be in a virtual test market system 20 of the present invention is a marketing simulation component 120. The marketing simulation component 120 may be thought of as any suitable agent based model which uses probabilistic analysis to engage in scenario generation.

It will be appreciated by one of skill in the art that a variety of products are currently available that simulate various scenarios. For example, Strat-X sells a business simulation program which is used by some consumer products companies. This product offers a simulation of business results given known business inputs. It may also be recognized by one of skill in the art that a conventional aggregate level volume share model could work to simulate various scenarios. It has been found during development of the present invention, however, that such currently available simulation capabilities have significant limitations. One limitation of these current models, for example, is that they depend upon analysis of past test markets to calibrate them and the model inputs are generally not very easy to understand by a lay marketing person. In order for such a model to be an effective predictor for a new test product or a new market (such as a newly entered country), there must be extensive recalibration of the model. Such recalibration can take years before acceptably accurate results are achieved.

The marketing simulation component 120 of the present invention may focus on agent-based simulations. An included capability may be to take a characterization of the effectiveness of the stimuli that are received by individual consumers (agents) and then modeling their behavior mathematically. It is desired that inputs into the marketing simulation component 120 are understandable. It is also desired that the user can easily estimate the approximate effectiveness of a totally new program, such as a new marketing program (even with a range). The marketing simulation 120 agent based model may then be able to simulate the emergent aggregate product choice behavior. Because an agent based model may look at inputs for every brand or product in a given category, the users of the system 20 may receive a volume estimation for every brand in the category.

As noted, the marketing simulation component 120 may comprise an agent based model. It may be desired that input to the simulation model include, but are not limited to, variables which describe elements of the marketing plan. These include but are not limited to coupons, samples, special events and conventional television or radio or other mass media. Specific measures that describe both the quality and quantity of these elements may be included. It may be desired that there are inputs associated for all brands in the category for the duration of the simulation. The simulation may be provided with the ability to turn these marketing elements on and off chronologically, as they are done in-market. The simulation may have the capability to adjust the strength (conversion efficiency) of each of the marketing plan elements to reflect reality.

Other inputs into the simulation may include product performance, such as data representing measures of perceived performance of the products in the category according to various attributes in addition to perceived importance of those attributes. It may be desired to take performance both before and after product usage into account via the inputs. This represents the possibilities that consumers can be either delighted or disappointed with a product's performance after usage. These data can be estimated separately. In one example, the disaggregate discrete choice utilities from the virtual launch component 110 are fed directly into the marketing simulation component 120. This relationship is represented by line 70 in FIG. 1.

Other input may include information describing consumer behavior. For example, measures of how sensitive consumers are to marketing message, product features and prices may be included. Other inputs may describe how frequently people talk to one another and where they shop. The marketing simulation component 120 may account for the diversity of habits normally encountered in the population and may also be able to handle unique segments of the population that have different behaviors and attitudes.

Market descriptors may also be included among the simulator inputs. These may include, but are not necessarily limited to descriptions of the products that are in the marketplace, the channels they are sold in and the prices at which they are sold in each channel. Provision may be made to account for promotions in specific channels and for prices to vary in any way necessary to replicate the real market. Additionally, provisions may be made for products to enter and leave the category or the specific channel.

Additional inputs into the simulator may represent social systems. For example, the model may include the ability to handle word of mouth components which happen either naturally or as the result of specific marketing programs. The program may handle either positive or negative word of mouth and may be able to accommodate a range of effectiveness of said word of mouth campaigns.

Pricing information may also be included among simulator inputs. The model may be designed to accommodate realistic pricing for each brand or product in a given category. In one example of a marketing simulation component 120, the same pricing data as shown on the shelves of the virtual launch component 100 is used. Again, this feed of information from the virtual launch component 100 to the marketing simulation component 120 is represented by line 70 in FIG. 1. Additionally, it may also be desired to use the pricing utilities from the disaggregate discrete choice model which may be fed directly into the marketing simulation 120 model.

The marketing simulation 120 model may be able to handle repeat purchases in a realistic manner. The repeat rate can be input directly based on category knowledge, or be input directly from the repeat data collected in the transaction component 110. This relationship is represented in FIG. 1 by line 80. Alternatively, such repeat purchase input can be calculated as a result of a detailed description of the “agent's” tasks that are performed on a periodic basis. If the latter approach is used, then task frequency, amount of product used for each task, and the appropriateness of each product for each task could be specified.

The virtual test market system 20 of the present invention is believed to differ from currently available systems in several respects. It has been noted that individual components of the test market system 20 are to some extent currently available. For example, existing “on-line” shopping forums may be thought of as similar to the transaction component 110. Similarly, it is noted that various agent based simulation models are known in the art for a myriad of purposes. The virtual test market system 20 of the present invention, is coordinated, and therefore, it expected to yield significantly more accurate modeling of actual consumer behavior. In preferred executions, actual consumers who are representative of target consumer groups will interact with the virtual launch 100 and the transaction 110 components. This interaction will generate data based upon actual consumers' reaction to market-like conditions. These data are expected to be accurate even for new markets and new products because they are based upon direct measurement and not upon estimations from previously collected information. The virtual launch 100 and transaction 110 components may be capable of generating direct measurements of choice probability, usage, and repeat purchase rate, as well as price-sensitivity, and effectiveness of marketing plan components. These measurements may be fed directly (either electronically, or by manual data entry) into the marketing simulation component 120 such as is shown by lines 70 and 80 in FIG. 1.

As noted it is not necessary that this “feeding” of inputs be automated. Rather, the inputs into the marketing simulation 120 are based upon measured data (as generated by the virtual launch 100 and transaction 110 components) rather than estimated data. The marketing simulation component 120 can then be used to generate highly realistic predictions of consumer behavior on the bases of actual consumer reactions to the physical embodiments of the test product itself used in direct comparison to competitive products. The marketing simulation component 120 may also be used to engage in scenario generation and evaluation. FIG. 1 depicts by line 90 a “loop” in the marketing simulation component 120. While this feature is not necessary or required, it is one advantage which a system of the present invention may have over conventional test marketing approaches. A user may vary the inputs into the marketing simulation 120 engage in various follow up analyses. In other words any desired number of “what if?” cases may be evaluated. This analysis is difficult in conventional test markets because of the difficultly in varying the stimuli shown to consumers, only one set of data may be available. Any variations from such data would necessarily require judgment and estimation rather than measured data.

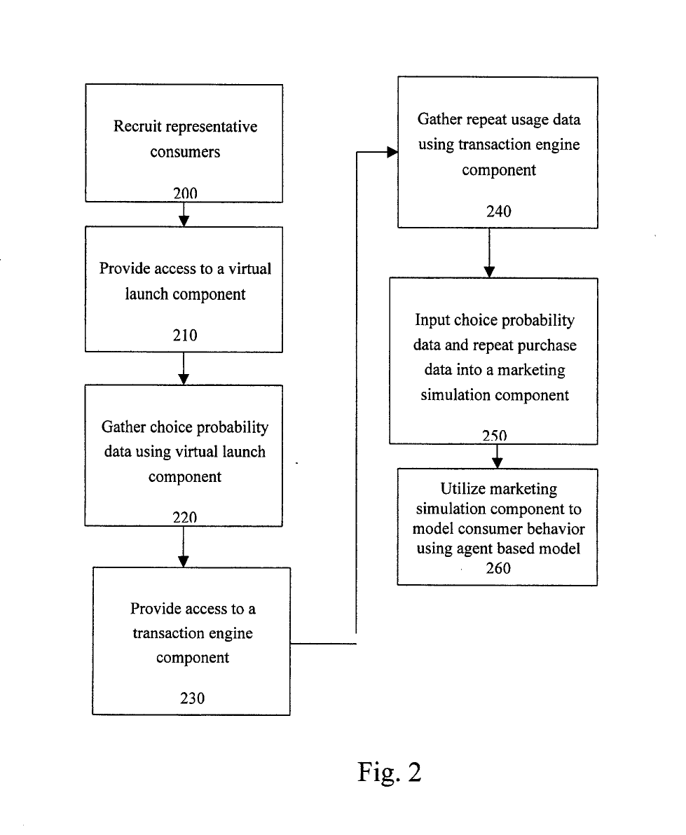

The present invention may also be practiced as a method of conducting a test market. FIG. 2 depicts the steps which may be included as part of a method of the present invention. In the example shown in FIG. 2, a first step 200 may comprise recruiting of a representative panel of consumers. This recruiting may be accomplished using any suitable means such as those typically known in the art. Any of techniques and considerations described above with respect to desired characteristics of “representative” consumers may be applied to this step.

Another step 210 may comprise providing the representative consumers access to a virtual launch component. The virtual launch component may be designed with any of the features or characteristics previously described with respect to a system of the present invention.

A step 220 of gathering choice probability data using the virtual launch component may also be included. Additional a step of providing access to a transaction component 230 may be included. This access may be provided to the same representative consumers previously recruited, or may be provided to another group of consumers. It may be desired to engage in another recruitment step between steps 220 and 230.

Another included step may be gathering of repeat purchase data using the transaction component 240. Also, a step of inputting the choice probability data and repeat purchase date into a marketing simulation component 250 may be included. The method may also include a step of utilizing the marketing simulation component to model consumer behavior using an agent based model. This step is depicted in FIG. 2 as 260. Any of the features, descriptions, or characteristics described above with respect to systems of the present invention may be included when practicing a method according to the present invention.

While particular embodiments of the present invention have been illustrated and described, it would be obvious to those skilled in the art that various other changes and modifications can be made without departing from the spirit and scope of the invention.

What is claimed is:

1. A test market system comprising:
a. a virtual launch component, wherein said virtual launch component is capable of generating data regarding product choice probability,
b. a transaction component, wherein said transaction component is capable of generating data regarding product repurchase, and
c. a marketing simulation component, wherein said product choice probability data and said product repurchase data are input into said marketing simulation component, and wherein said marketing component contains an agent based model which utilizes said product choice probability data and said product repurchase data.

2. The system of claim 1 wherein said product repurchase data comprises information regarding both product repurchase probability and frequency.

3. The system of claim 1 wherein said virtual launch component is capable of exposing consumers to marketing materials.

4. The system of claim 1 wherein said transaction component is capable of exposing consumers to marketing materials.

5. The system of claim 1 wherein said virtual launch component is executed via one or more interactive computer based systems.

6. The system of claim 1 wherein said transaction component functionality is provided using one or more interactive programmed computers.

7. The system of claim 1 wherein said transaction component functionality is provided using printed catalogues.

8. The system of claim 1 wherein said system is capable of modeling the market input of a competitive response wherein said competitive response is selected form the group consisting of: issuing coupons, advertising, pricing specials, and end-aisle displays.

9. A method of conducting a test market, said method comprising the steps of:
a. recruiting a representative plurality of consumers,
b. providing said consumers with access to a virtual launch component,
c. gathering data regarding the product choice probability of said consumers using said virtual launch component,
d. providing consumers access to a transaction component,
e. gathering repeat purchase data using said transaction component,
f. inputting said choice probability data and said repeat purchase data into a marketing simulation component, and
g. utilizing said marketing simulation component to model consumer behavior using an agent based model.

10. The method of claim 9 wherein between steps (c) and (d) there is a step of recruiting a second plurality of representative consumers.

11. The method of claim 9 wherein step (b) is accomplished by means of one or more programmable computers.

12. The method of claim 9 wherein step (d) is accomplished by means of one or more programmable computers.

13. The method of claim 9 wherein step (g) is accomplished by means of one or more programmable computers.
